(19) United States
(12) Patent Application Publication
(10) Pub. No.: US 2025/0228745 A1
(43) Pub. Date: Jul. 17, 2025

(54) PILL DEVICE APPARATUS, SYSTEM AND METHODS FOR INTRUSION DETECTION

(71) Applicant: ENPRO, INC., Addison, IL (US)

(72) Inventors: Grant Cook, Geneva, IL (US); Thomas Kohlert, St. Charles, IL (US); Scott Nicholson, South Elgine, IL (US)

(21) Appl. No.: 18/649,682

(22) Filed: Apr. 29, 2024

Related U.S. Application Data
(63) Continuation of application No. 17/110,150, filed on Dec. 2, 2020, now abandoned.

(51) Int. Cl. A61J 7/00; A61J 1/03; A61J 7/04; B67C 3/26

(52) U.S. Cl. CPC A61J 7/0076; A61J 1/03; A61J 7/0418; A61J 7/0436; B67C 3/2628; B67C 2003/2657

(57) ABSTRACT

The present disclosure is directed to a vent tube apparatus, system and methods incorporating a ball cage with a modified pill device design comprising a traceable material such as a Radio Frequency Identification (RFID) tag for use in conjunction with a filling machine during container filling operations for a quicker and more accurate detection of the location of the pill device to the extent it becomes detached from the ball cage during filling operations, and to increase the safety of the filling operation and reduce costs and time when a malfunction occurs.

### PRIORITY STATEMENT

The present application is a continuation of U.S. patent application Ser. No. 17/110,150, filed Dec. 2, 2020, which claims the benefit of U.S. Provisional Patent Application No. 62/943,025, titled Pill Device Apparatus, System And Methods For Intrusion Detection, filed Dec. 3, 2019, and U.S. Provisional Patent Application Ser. No. 62/955,543, titled Pill Device Apparatus, System And Methods For Intrusion Detection, filed Dec. 31, 2019; all of the foregoing incorporated by reference herein.

### FIELD OF THE DISCLOSURE

The present disclosure relates to a novel flat bottom or oval pill device, ball cage, traceable vent tube, or removable vent tube tip or cap incorporating one or more detectors or indicators for use in conjunction with a filling machine during filling operations to increase the safety of the filling operation and reduce the associated cost and time when a malfunction occurs.

The present disclosure relates to food or beverage filling machines and/or methods utilizing novel flat bottom or oval pill devices, ball cages, traceable vent tubes, or removable vent tube tips or caps incorporating a magnet, a Radio Frequency Identification (RFID) tag, or incorporates other types of tags or traceable material allowing for a quicker and more accurate detection of an intrusion and the location of the food or beverage in which the novel flat bottom and oval pill device, ball cage, traceable vent tube, or removable vent tube tip or cap, that has become detached from the filling machine during filling operations, is located.

In particular, the present disclosure relates to a particular design and configuration of a novel flat bottom or oval pill device, and the related ball cage design and shape that provides consistent orientation of the pill device and thus a consistent orientation of the RFID tag, or other detector or indicator, located in the pill device design. By changing the current polypropylene ball used in standard operations to the present novel pill device design and from a spherical to an oval or oblong shape, with or without a flat bottom, (or other similar shape), the orientation of the innovative pill device is consistent such that the magnet or RFID tag located in the pill device design is always known.

Once the location of the magnet or RFID tag or other detector or indicator is consistently known, the antenna or other indicator reader, detecting the RFID tag or indicator (and thus detecting the location of the pill device), can accurately and precisely know if the pill device has successfully entered and left the canister being filled, or if the pill device has inadvertently been left behind in a canister or other location.

### BACKGROUND OF THE DISCLOSURE

In the food and beverage industry there is a need for efficient and reliable manufacturing processes to quickly and safely manufacture and package the food and beverage product. Most food and beverage plants across the United States run continuously, 24 hours a day and 7 days a week, to meet the ever-increasing demands. With these stringent demands on their machines as well as personnel, most food and beverage plants have implemented some form of process control or automation. By using programmable logic controllers (PLCs) and various other logic controlling devices, elementary applications that used to require manual attention can now be done with machines.

In particular, the demand today for beverage containers filled with product, such as cola and beer, is greater than it has ever been and continues to grow. These containers can be glass bottles, aluminum cans or any type of canister that can store, for example, consumable beverages, automobile product, hair and skin care product, and any other liquid or semi-liquid product that is packaged and distributed in such a container. These container packages can be any size and shape, such as those found in 12-ounce cola or beer cans and bottles, and the various bottles containing hair care product. These containers can be made from many different materials, such as glass, plastic, aluminum, tin among others, and are enclosed, after being filled with product, using a type of cap or top attached by screwing onto the container, crimping, pressing or heat sealing, or in other ways to enclose the product in the container.

In order to meet this demand for liquid and semi-liquid product, high speed, automatic filling machines are incorporated in the filling process. These automatic machines can load, fill, enclose, and box up thousands of these containers each minute in a high-speed operation. These automatic filling machines load the empty containers onto a conveyor and move the bottles into a location on the machines where the containers come in contact with the filling machine and are filled with product. Once filled, the containers are enclosed or sealed and are quickly moved away from the filling station, and boxed up or packaged along with other filled containers to be shipped or distributed to retail centers and the like.

In such a high-speed operation, when an accident or mistake occurs, hundreds or thousands of containers may inadvertently be filled before the filling machine or process can be halted. In these situations, the hundreds or thousands of containers filled after the accident may need to be discarded, wasting time and money to determine which bottles were filled after the accident.

The fill process will vary depending on the product being filled, and various factors, such as the temperature and viscosity of the product, the beverage gas, the effect of those gases and related pressure characteristics during the filling process. Accordingly, the filling process and related conditions can be optimized and maximized monitoring and controlling these factors. For purposes of this application and for simplicity, most of the examples herein will refer to a carbonated beverage filling process, although the apparatus, system and methods described herein relate to any similar type of filling process.

Further, the filling process cannot alter the food or beverage being filled. Thus, when planning a filling system it is important to match the appropriate filling steps to the beverage characteristics and container. The steps of the filling process include some or all of the following: evacuation of the container, flushing the container with gas, pressurizing the container with gas, filling the container with one or multiple speeds, fill level correction (in certain cases), and settling the product.

Evacuation is used mostly on rigid containers in which a vacuum process removes upwards of 90% of the air content in the container prior to pressurizing with gas. Evacuation becomes more important when the contents being filled are oxygen sensitive and the may be repeated at other times throughout the filling process. Additionally or alternatively, the container may be flushed with gas. This is done mostly with flexible containers, such as PET bottles and aluminum cans, which may not be able to withstand a vacuum. The flushing step takes place at the time that the fill valve is located at the container and usually uses gas from the filling ring bowl until both pressures are the same.

Next, filling takes place when the fill valve opens and the product flows over, around the vent tube, and into the container. As the container fills, gas in the containers is displaced by the product and flows through the vent tube and out of the container into the filler ring bowl, until the container is full. As an example, the vent tube may contain an electronic probe to detect product and stop filling. Accordingly, the vent tube vents the gases being used while filling the container with fluid. The process needs to be extremely accurate, and as a result, most vent tubes are designed at specific lengths to achieve each specific fill level per filling machine.

Fill level correction may be incorporated when the cost of product is high to save product. In the most commonly used fill level correction step, the container is first overfilled with product and then the product is extracted using a vacuum through the vent tube. Finally, by settling, the pressure in the container is lowered and the beverage is allowed to settle as it is lowered from the fill valve.

The vent tubes used in the filling process described above usually are configured with an elongated, hollow, cylindrical tube extending the length of the tube, which allows the vent tube to enter the container opening during the fill process without touching the container. As described above and in U.S. Pat. No. 3,736,966, which is incorporated by reference herein, the product can flow over the vent tube into the container. The lower tip of the vent tube is usually closed and one or more holes are provided so that any gas or air in the container can be displaced through the vent tube during the filling process, minimizing or eliminating the possibility of a container exploding during filling.

Additionally, vent tubes can be configured for canister filling by incorporating a ball cage and check ball assembly at the lower end of the vent tube for preventing gases from leaking during the filling operation. The ball or sphere is usually made up of a thermoplastic such as polypropylene, and is captured in the vent tube ball cage, but is free to move up and down (the z-axis) in the opening, as understood by one having ordinary skill in the art. When the ball moves to the top of the ball cage, the ball fits into the vent tube opening. The circumference of the ball is such that when it moves to the top of the ball cage, it will block the bottom of the vent tube opening thereby preventing gases from leaking.

However, as the captured polypropylene ball moves around in the vent tube, because the ball is spherical, the ball can rotate in all directions, in effect rotating inside the vent tube. To the extent that the polypropylene ball can move on the z-axis, it will function properly. To the extent that the polypropylene ball rotates and makes continuous contact with the insides of the vent tube ball cage, the ball may be deformed or reduced in size over time, which will lead to the ball falling out of or detaching from the vent tube ball cage. The ball may thus fall into a canister or container.

Traditionally, filling machines for glass containers use a vent tube made of stainless steel or a stainless food-grade plastic hybrid. For filling aluminum containers, the vent tube is usually made from some form of food-grade plastic, such as Delrin®. Vent tubes can also use a ball and cage system as described in U.S. Publication No. US20050199314 A1, which is incorporated by reference herein.

In certain instances, the high-speed automatic filling machines allow for removing and replacing the vent tube or a portion of the vent tube, such as the cap, as described in U.S. Pat. Nos. 4,049,030 and 5,878,797, which are incorporated by reference herein. In other situations, a removable vent tube cap or tip can be attached, either by using threads on the cap, a slot, a snap-in configuration or some other manner, as understood by one having ordinary skill in the art.

Due to the high speeds and constant use of these filling machines, occasionally a vent tube may detach from the filling machine and fall into the product container. When either of these event occur (the ball falling from the vent tube ball cage, or the vent tube falling from the filling machine), there are minimal systems in place to halt the filling process, locate the detached vent tube, or portion thereof (such as a cap) or ball, repair the filling machine and begin the process again.

Each minute that the process is halted equates to thousands of unfilled containers, as filling machines can run at speeds of 1650 cans per minute. Further, the longer the process continues the more filled containers that will have to be examined to find the detached vent tube or ball. In many situations, the containers filled with product that were boxed up or packaged after the vent tube or ball became detached are merely discarded, increasing the costs of the accident.

Similarly, counter pressure fillers or Isobaric Fillers are devices used to fill bottles or aluminum cans from a pressurized or non-pressurized bulk storage tank. The goal is to avoid a reduction in the carbonation of the liquid being filled, as understood by one having ordinary skill in the art.

Counter pressure fillers fill containers, canisters or bottles using a filling tube from the top of the container using a diffuser to distribute liquid around the walls of the container while filling. This reduces or avoids foaming of the liquid during the filling process. The center of the filling tube utilizes a smaller return tube fitted inside, which allows the carbon dioxide in the pressurized container to escape to the top of a filling tank.

This process provides for more product to fill the container while the carbon dioxide escapes the container. Although not used as much, the process can be completed by filling from the bottom up, but this is more expensive to implement. Fillers have two inputs-one for the carbon dioxide gas and the other for the actual liquid. Filler designs also include a vent to allow venting of gas from the top of the bottle during the filling operation. By controlling the vent and valves on each input, the pressure and speed of filling and venting can be controlled.

In use, a counter pressure filler fills the container by maintaining constant carbon dioxide gas pressure on the liquid as understood by one having ordinary skill in the art. The container is initially pressurized with the carbon dioxide, the fill valve is opened, and the carbon dioxide is vented to allow the container bottle to fill from the bottom.

Some of the current systems used to check for detached stainless steel vent tubes or the polypropylene ball include the use of inductive or capacitive sensors, vision systems or other ultrasonic inline systems. Additionally, systems for determining when a vent tube or polypropylene ball has become detached and fallen into a container include the electromagnetic detection fields or X-ray based technologies. Some of the manufactures of these technologies include Omron Corporation, Industrial Dynamics Company, and the Fortress Technology Inc, among others.

However, most of these inspection systems need to have direct access to each container after it has been filled with product, and are used as a way to detect the vent tube or polypropylene ball by examining each container. This process slows down the filling line either because each container must be examined, or takes longer time than necessary to find the container in which the vent tube or polypropylene ball has fallen if each container has not been examined.

Further, some of the systems work better with metal vent tubes, while other systems work better with plastic vent tubes or polypropylene balls creating inconsistencies, or the need for additional equipment when changing to different vent tubes. For example, when a plastic vent tube or a polypropylene ball falls into a can made of aluminum at a filling plant, the inductive and capacitive technologies cannot detect the plastic (foreign) object through the aluminum can.

There is currently no apparatus, system or method that incorporates an indicator or detector, such as an RFID tag or a magnet, into a novel flat bottom or oval pill device, ball cage, traceable vent tube, or removable vent tube tip or cap for use during filling operations, that increases the safety of the filling operation and reduces the costs and time when a malfunction occurs, such as when a vent tube or polypropylene ball inadvertently detaches from the filling machine and falls into the container or canister.

There is also no apparatus, system or method relating to novel flat bottom and oval pill devices, ball cages, traceable vent tubes, or removable vent tube tips or caps incorporating an RFID tag or a magnet or another traceable material that allows for a quicker and more accurate determination of the occurrence and location of a vent tube or ball that has become detached from a filling machine during filling operations. The present disclosure satisfies these needs.

### SUMMARY OF THE DISCLOSURE

In order to solve the above-mentioned shortcomings in filling operations, the present disclosure utilizes apparatus, system and/or methods for determining the location of a novel flat bottom or oval pill device, ball cage, traceable vent tube, or removable vent tube tip or cap when the filling machine malfunctions and one of these devices, or a portion thereof, becomes detached from the filling machine and, in special cases, falls or intrudes into a container being filled. In particular, the disclosure utilizes a novel flat bottom or oval pill device, ball cage, traceable vent tube, or removable vent tube tip or cap modified in some way with a traceable material, such as an RFID tag or a magnet, and can incorporate a system and methods for scanning a filling machine, as well as food or beverage containers, using sensing technologies, such as RFID technology.

Additionally, the modified pill device, such as the flat bottom or oval pill device design, differs from the standard polypropylene or thermoplastic ball in that the shape of the pill device is oblong and not spherical. The modified shape allows the pill device to continue moving in the z-axis inside the ball cage without tumbling. Thus, the pill device is capable of performing its intended function of moving up on the z-axis to engage the vent tube opening to prevent the escaping of gases when needed.

Although other designs are possible, the modified pill device design disclosed herein differs from the polypropylene or thermoplastic ball in that the shape of the pill device is oval or spherical on the first side and either oval or spherical, or flat or beveled on the second side, and not spherical on the second side. As such, the first novel pill device design is oval or spherical on one side and flat bottom or beveled on the other side, while the second novel pill device design is oval or spherical on both sides. Other designs can be incorporated in which the shape allows the particular device to continue moving in the z-axis inside a ball cage without tumbling. Thus, the pill device is capable of performing its intended function of moving up on the z-axis to engage the vent tube opening to prevent the escaping of gases when needed.

The shapes described above also allow for the incorporation of an RFID tag or another indicator in a location in the novel pill device such that the RFID tag (or whichever device is used to track the device), is always in the same relative location in the ball cage. For example, since the shape of the novel pill device limits the device rotation inside the ball cage, the RFID tag or other indicator will always be on a plane perpendicular to the direction of the vent tube, if that is the desired location. Other orientations can be used to meet systems requirements. Since the shape of the novel pill device only allows for rotation or movement in one axis (besides the z-axis), there will be less contact with the inside of the ball cage and less damage to the novel pill device as it is used in the filling operation.

As such, the present disclosure solves the problems facing the packaging industry, and in particular, the beverage filling industry as described above. The present disclosure incorporates a solution for consistent detection of a novel flat bottom or oval pill device, ball cage, traceable vent tube, or removable vent tube tip or cap intrusion into a container, which will exceed the current standards at specific beverage manufacturing plants.

At large automated beverage manufacturing plants, aluminum cans are a commonly used container for product. As described above, when a plastic vent tube or a propylene ball falls into an aluminum can as it is being filled, the inductive and capacitive technologies normally used to detect metal vent tubes or thermoplastic balls, cannot detect the foreign object through the aluminum can. As a result, expensive X-ray systems must be used or the product is considered wasted.

The present disclosure solves this inherent problem by incorporating or implementing an RFID tag or a magnet into each novel flat bottom or oval pill device, ball cage, traceable vent tube, or removable vent tube tip or cap and associated monitoring systems. The incorporated RFID tag can be used on metal, metal-plastic hybrid, ball cage, plastic vent tubes, vent tube caps and into the novel pill device designs with the same result. By placing an in-line identification gate or RFID scanner or reader, or another similar reader, after the filling process occurs, and a continuous monitoring system on the filling machine any such pill device, ball cage, traceable vent tube, or removable vent tube tip or cap can be reliably tracked if it becomes detached from the filling machine during the filling process.

By tagging the pill device, ball cage, traceable vent tube, or removable vent tube tip or cap with an RFID transponder, a magnet or other tagging technologies, routine consistency checks will not have to be performed. Further, other materials may now be considered as containers for the packaging side of the manufacturing facilities.

The vent tube and pill device detection systems used in conjunction with the present disclosure has several components, such as chips, tags, readers and antennas. By incorporating an RFID tag, transponder, or other tagging technology into the vent tube or pill device designs, these devices can be tracked using the same transponder or tag reading system as described above.

Since, in the case of an RFID tag, the transponder is created by attaching a small silicon chip to a small flexible antenna; the chip can be used to record and store information. To read the transponder and locate the specific vent tube or pill device designs, the RFID reader sends out a radio signal to be absorbed by the antenna and reflected back as a return signal delivering information from the transponder chip memory.

In use, the container filling machine operates in its normal manner with empty containers sent down a conveyor to the filling section of the system. The vent tube (with or without the pill device designs) is then lowered (or the empty container is raised) to come in contact or near contact with the container. The container is filled with the product as described above, and the pill device, ball cage, traceable vent tube, or removable vent tube tip or cap is removed from the filled container. The filled container is then covered and/or sealed. This filling process fills thousands of containers each minute.

In the present disclosure, a traceable vent tube cap can be attached to an existing vent tube to allow standard vent tubes to become traceable vent tubes. Alternatively, the modified pill device design containing a traceable device can be used in a ball cage instead of a polypropylene ball, to allow standard vent tubes or ball cages to become traceable vent tubes or ball cages.

If, during these high-speed operations, a vent tube malfunctions (i.e., the vent tube, ball cage or pill device detaches or sheers from the filling machine, and falls into the container), the RFID transponder incorporated into the vent tube, vent tube cap, modified pill device (or a combination of the devices) will likewise fall into the filled container.

Using the vent tube detection system, the system can have immediate information that the vent tube has detached from the filling system and precisely which container the pill device, ball cage, traceable vent tube, or removable vent tube tip or cap is located. Depending on the type of system and the indicator being used, the reader of the vent tube detection system can be anywhere from 1 foot to 20 to 30 feet from the location of the container or filling machine. Further, handheld RFID tag or magnetic readers can be used at the time of the malfunction to assist in finding the broken pill device, ball cage, traceable vent tube, or removable vent tube tip or cap.

The pill device, ball cage, traceable vent tube, or removable vent tube tip or cap detection system can be set up at various locations in the filling plant in order to make sure that a pill device, ball cage, traceable vent tube, or removable vent tube tip or cap has not become accidentally detached into a filled container before the container is shipped out of the plant.

These and other aspects, features, and advantages of the present disclosure will become more readily apparent from the attached drawings, the detailed description of the preferred embodiments, and the recited claims, which follow.

### DRAWINGS

The preferred embodiments of the disclosure will be described in conjunction with the appended drawings provided to illustrate and not to the limit the disclosure, where like designations denote like elements, and in which:

FIG. 1 illustrates a filling machine in accordance with one embodiment of the present disclosure;

FIG. 2 illustrates an inspection system for inspecting empty and full containers in accordance with the present disclosure;

FIGS. 3A and 3B illustrate a vent tube incorporating indicators in accordance with an embodiment of the present disclosure; and

FIG. 4 illustrates an exemplary indicator detection system in accordance with an embodiment of the present disclosure.

FIG. 5 illustrates an exemplary replaceable and/or traceable vent tube cap incorporating an indicator in accordance with an embodiment of the present disclosure.

FIG. 6 illustrates an exemplary portion of a standard filling machine indicating a standard vent tube.

FIG. 7A illustrates an exemplary vent tube ball cage incorporating a standard ball in accordance with the prior art.

FIG. 7B illustrates an exemplary vent tube ball cage incorporating a modified pill device in accordance with an embodiment of the present disclosure.

FIGS. 8A and 8B illustrate an exemplary modified pill device incorporating an oval design in accordance with an embodiment of the present disclosure.

FIG. 9 illustrates an exemplary modified pill device incorporating a flat bottom design in accordance with an embodiment of the present disclosure.

FIG. 10 illustrates an exemplary ball cage incorporating a flat bottom pill device in accordance with an embodiment of the present disclosure.

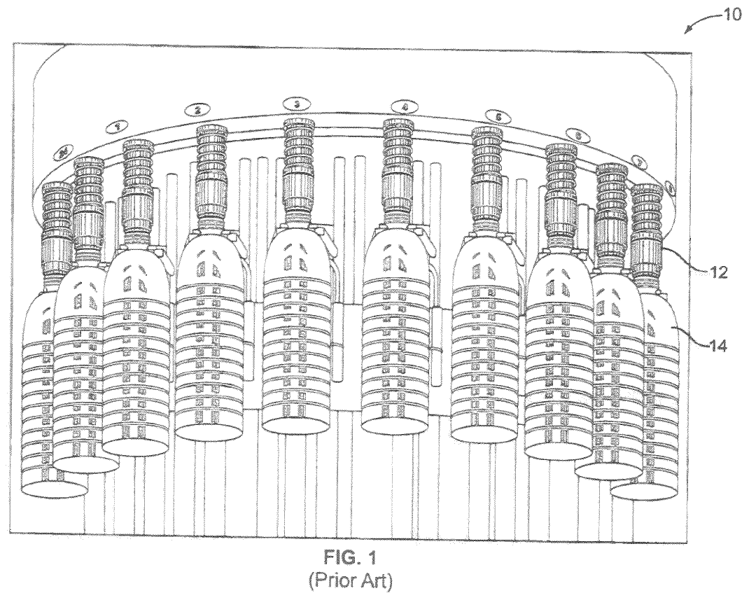

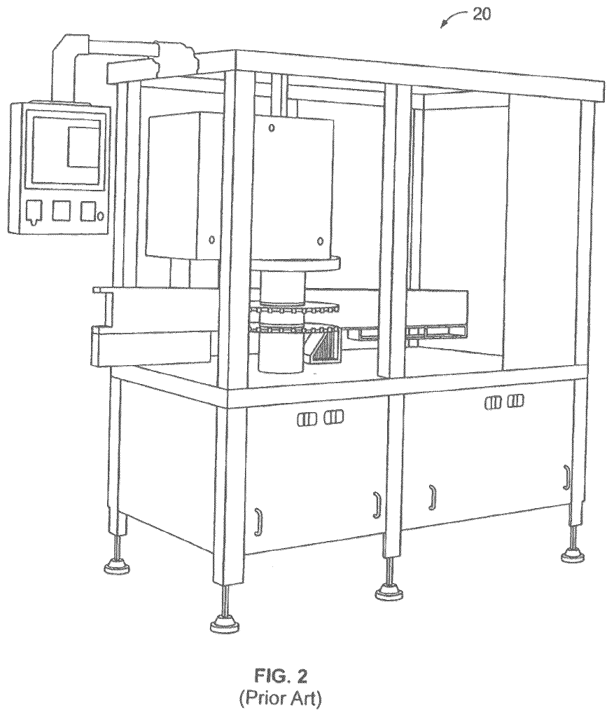

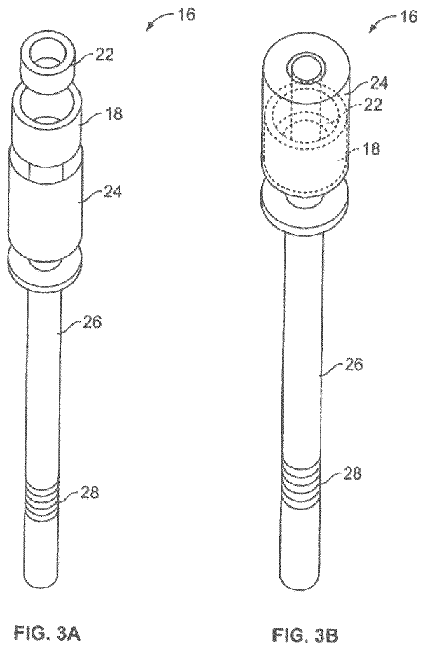

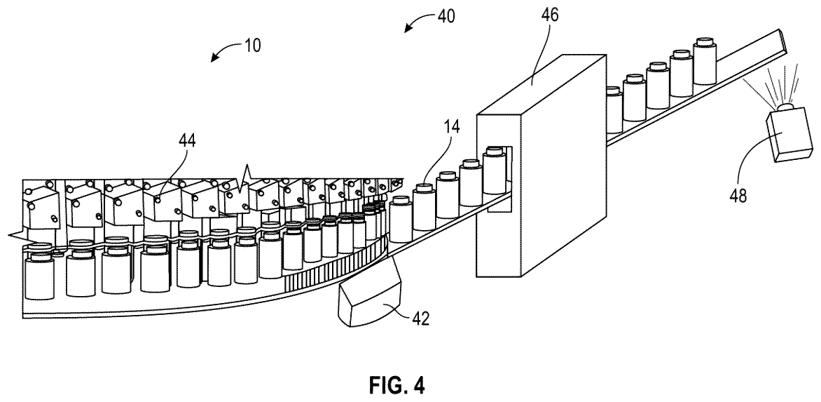

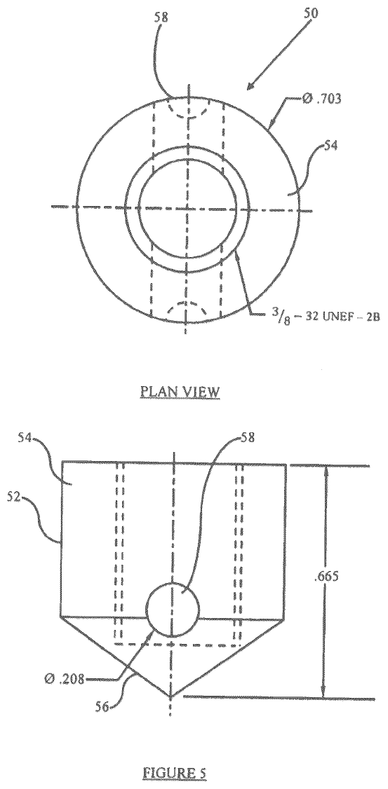

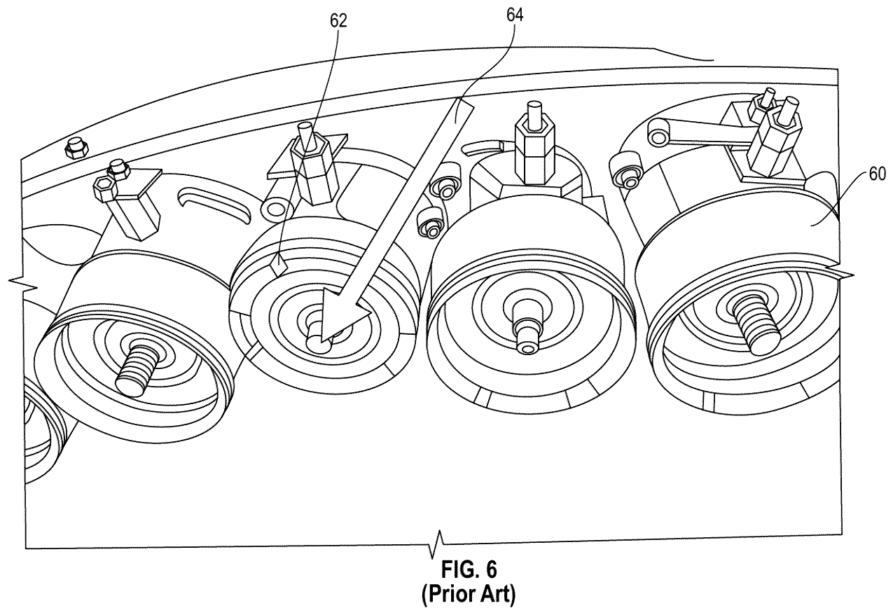

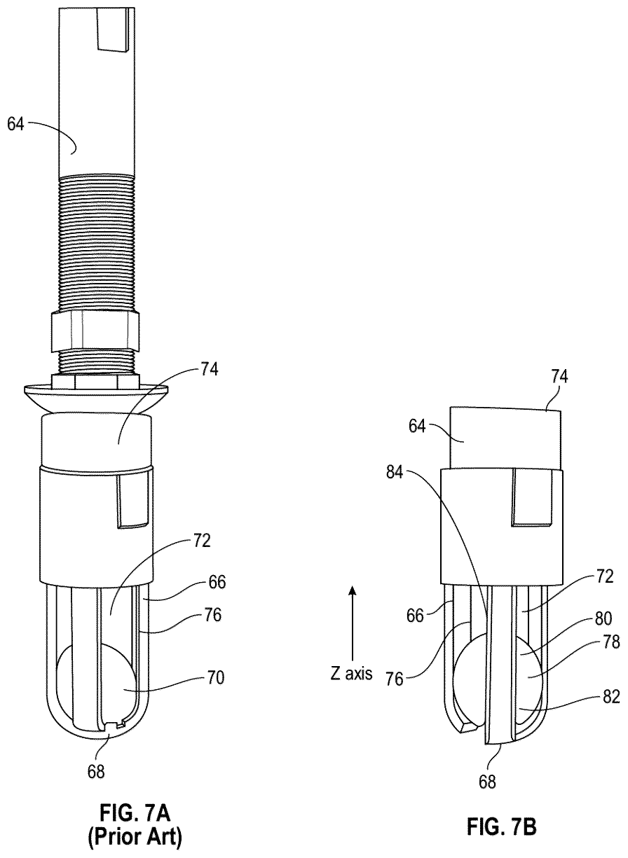

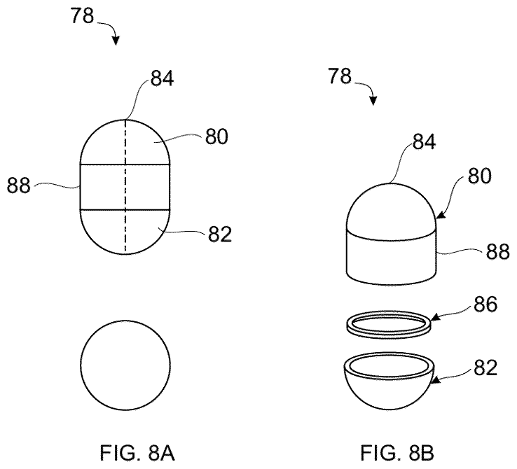

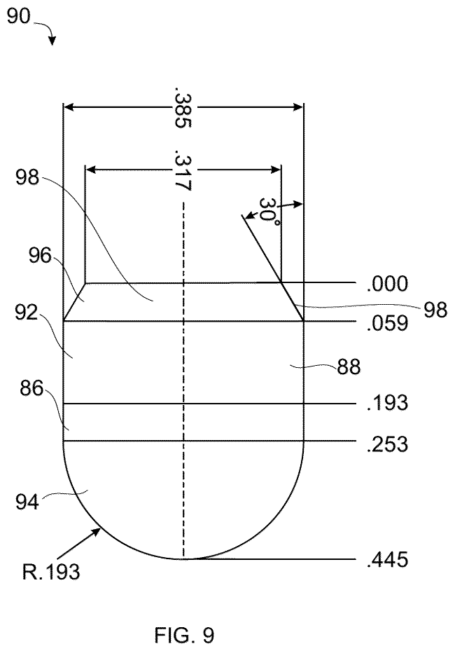

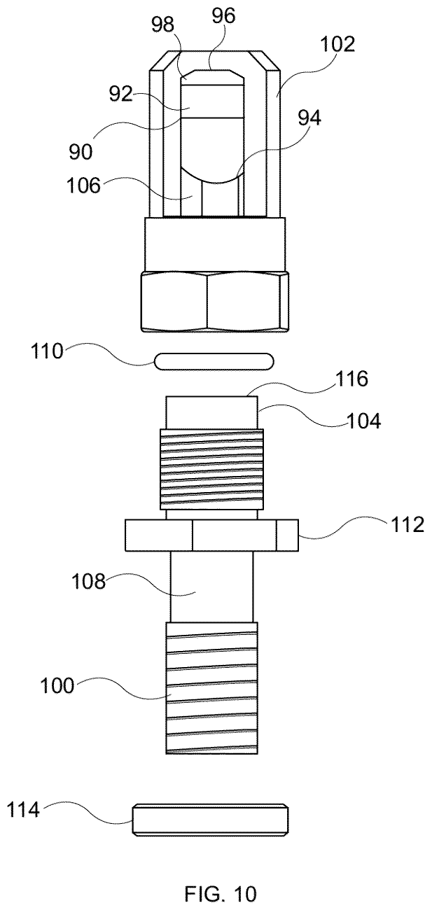

1. A vent tube and ball cage apparatus for use in filling a container during a filling process in which the ball cage is attached to the vent tube, and the vent tube is attached to a filling machine, comprising:
a vent tube body, said vent tube body being hollow and comprising a vent tube opening, said vent tube body configured to be attached to a filling machine and configured to vent a gas from the container during the filling process;
a ball cage, said ball cage comprising an opening, said ball cage attached to said vent tube body at said vent tube opening;
a pill device, said pill device having an oblong shape and having a bottom portion that is spherical, said pill device configured to be located inside said ball cage opening, said pill device further comprising a top portion, and a cylinder portion, said cylinder portion providing said oblong shape of said pill device; and
an indicator, said indicator being housed in said pill device, such that if said pill device is removed from said filling machine, said pill device can be detected using an indicator detection system.

2. The vent tube and ball cage apparatus in claim 1, wherein said top portion comprises a beveled edge.

3. The vent tube and ball cage apparatus in claim 1, wherein said top portion comprises a flat bottom.

4. The vent tube and ball cage apparatus in claim 1, wherein said top portion comprises a spherical end.

5. The vent tube and ball cage apparatus in claim 1, wherein said indicator is a Radio Frequency Identification tag.

6. The vent tube and ball cage apparatus in claim 1, wherein said indicator detection system is a Radio Frequency Identification reader.

7. The vent tube and ball cage apparatus in claim 1, wherein said housed in said pill device means enclosed during an injection molded process.

8. The vent tube and ball cage apparatus in claim 1, wherein said housed in said pill device means attached during a machining process.

9. The vent tube and ball cage apparatus in claim 1, wherein said pill device is prevented from rotating in more than one axis due to said oblong shape.

10. The vent tube and ball cage apparatus in claim 1, wherein said indicator is a magnet.

11. A pill device for use with a vent tube and ball cage apparatus for filling a container in a filling machine in which the vent tube is configured to vent a gas from the container during a filling process, comprising:
a top portion, a cylinder portion and a bottom portion, said pill device configured such that said cylinder portion creates an oblong shape;
said pill device configured to be located in a ball cage opening in said ball cage, such that said ball cage prevents said pill device from rotating in more than one axis due to said oblong shape;
said bottom portion configured in a spherical shape;
an indicator, said indicator being housed in said pill device, such that if said pill device is removed from said ball cage opening, said removal from said ball cage opening can be detected using an indicator detector.

12. The pill device in claim 11, wherein said top portion comprises a beveled edge.

13. The pill device in claim 11, wherein said top portion comprises a flat bottom.

14. The pill device in claim 11, wherein said top portion comprises a spherical end.

15. The pill device in claim 11, wherein said indicator is a Radio Frequency Identification tag.

16. The pill device in claim 11, wherein said indicator detector is a Radio Frequency Identification reader.

17. The pill device in claim 11, wherein said housed in said pill device housing means enclosed during an injection molded process.

18. The pill device in claim 11, wherein said housed in said pill device housing means attached during a machining process.

19. The pill device in claim 11, wherein said indicator is a magnet.
